(19) United States
(12) Patent Application Publication
(10) Pub. No.: US 2008/0171465 A1
(43) Pub. Date: Jul. 17, 2008

(54) DISC DRIVE HEAD STACK ASSEMBLY

(75) Inventors: Louis D. Lauriano, Long Beach, CA (US); Douglas L. Wagner, Newbury Park, CA (US)

Correspondence Address: WOODCOCK WASHBURN, LLP, CIRA CENTRE, 12TH FLOOR, 2929 ARCH STREET, PHILADELPHIA, PA, 19104-2891, US

(73) Assignee: FCI Americas Technology, Inc., Reno, NV (US)

(21) Appl. No.: 11/624,102

(22) Filed: Jan. 17, 2007

(51) Int. Cl. H01R 13/60

(52) U.S. Cl. 439/567

(57) ABSTRACT

A head stack assembly (HSA) that may eliminate the need for a plurality of separate components by molding all of the HSA parts together into a single connector is disclosed. Such an HSA may include a single connector having a mating interface and a fastener extending from a surface of the connector, a flex circuit attached to the connector, and a gasket seal placed on the upper surface of the connector. The fasteners may be compliant pegs that are pressed into a disc housing, thereby holding the gasket and connector in place. When the HSA is correctly oriented, the mating interface of the connector may mate with a printed circuit board (PCB) mount connector. Because a number of HSA components are molded into a single-piece connector, metal screws may not be required, thereby reducing the loading forces and warp on the PCB.

### BACKGROUND OF THE INVENTION

A typical head stack assembly (HSA) is generally made up of as many as six components, and requires the use of screws to hold a compression load between a printed circuit board (PCB) and the drive HSA connector. Generally, a head stack assembly includes a plastic flex bracket, an aluminum stiffener, a Kapton backing, a flex assembly, a compression connector, and a gasket seal, all held together by metal screws. High loading forces and warping of the PCB may be created by such a design.

It would be desirable, therefore, if an HSA were available that did not require the use of metal screws so that warping in the PCB may be reduced.

### SUMMARY OF THE INVENTION

The invention provides an HSA that eliminates a majority of the aforementioned components by molding many of the HSA parts together, so that metal screws are unnecessary and warping may be reduced.

Such an HSA may include a single-piece connector having a mating interface and a retention fastener extending from a surface of the connector, a flex circuit attached to the connector, and a gasket seal placed on the surface of the connector. The fasteners may be compliant pegs that may be pressed into a disc drive housing of a disc drive, thereby holding the gasket and connector in place. When the HSA is correctly oriented, the mating interface of the connector may mate with a PCB mount connector. Because a number of HSA components are molded into a single-piece connector, metal screws may not be required, thereby reducing the loading forces and warp on the PCB.

### BRIEF DESCRIPTION OF THE DRAWINGS

FIG. 1A is an exploded isometric view of an example embodiment of a head stack assembly.

FIG. 1B is an isometric view of the head stack assembly shown in FIG. 1A.

FIG. 2A is an isometric view of an embodiment of a head stack assembly connector.

FIG. 2B is a top view of the connector shown in FIG. 2A.

FIG. 3A is an isometric view of the connector shown in FIG. 2A with the addition of a gasket.

FIG. 3B is a side view of the connector shown in FIG. 3A.

FIG. 3C is an end view of the connector shown in FIG. 3A.

### DETAILED DESCRIPTION OF ILLUSTRATIVE EMBODIMENTS

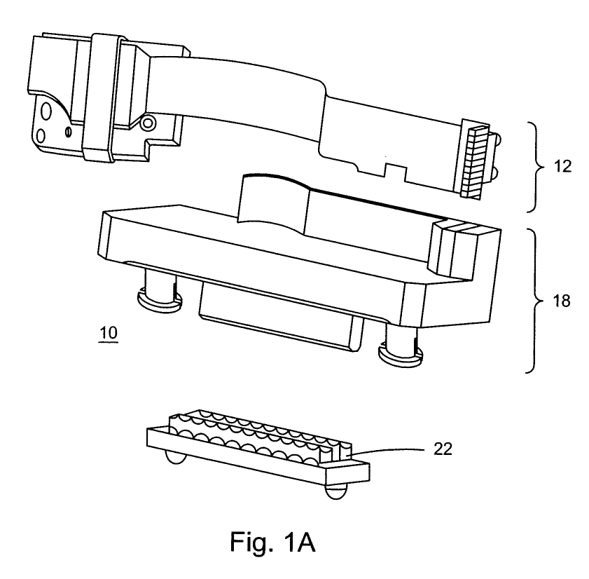

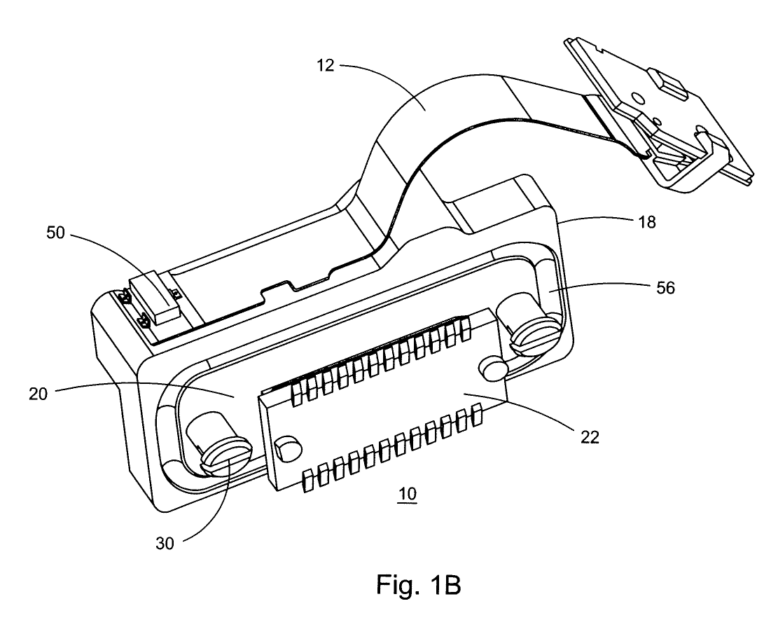

FIGS. 1A and 1B depict an embodiment of an HSA 10 for a disc drive. As shown in FIGS. 1A and 1B, the HSA 10 may include a flex circuit 12, and a connector 18. The connector 18 may be adapted to mate with a printed circuit board (PCB) mount connector 22. The HSA 10 may reduce the number of components found in a typical HSA by molding the connector 18 into a single unit. Accordingly, the connector 18 may provide all of the functional characteristics of the components of a typical HSA.

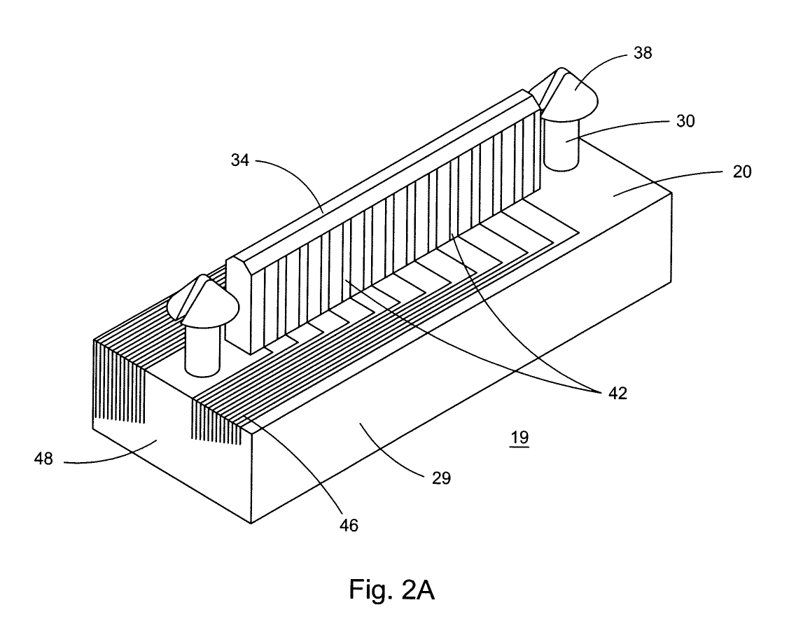

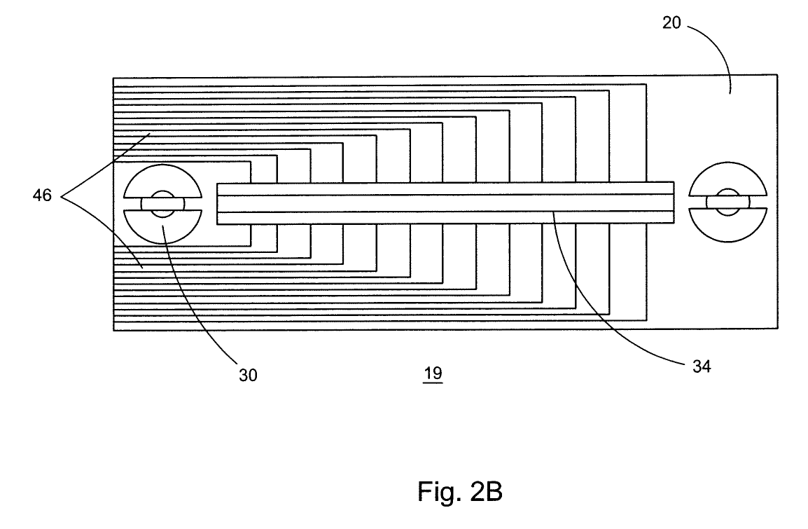

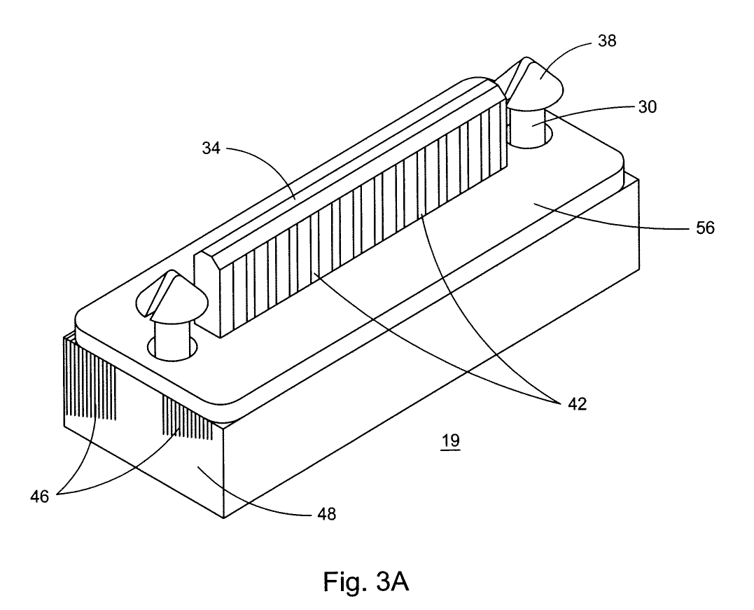

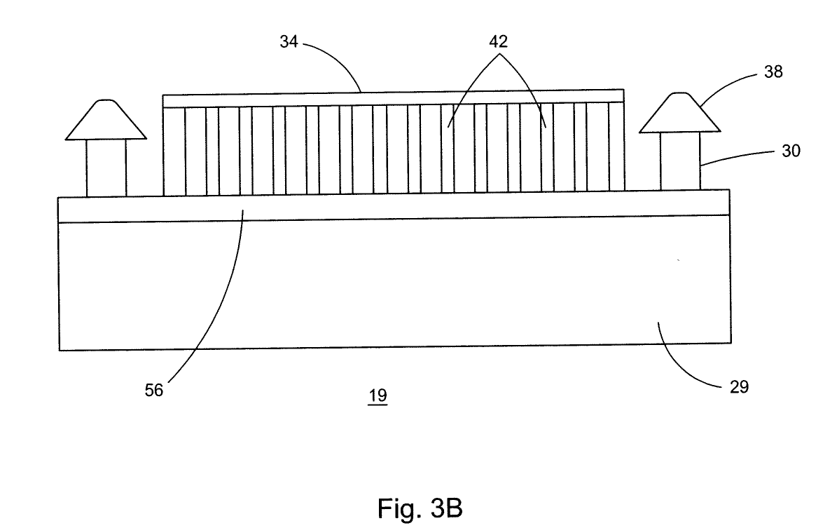

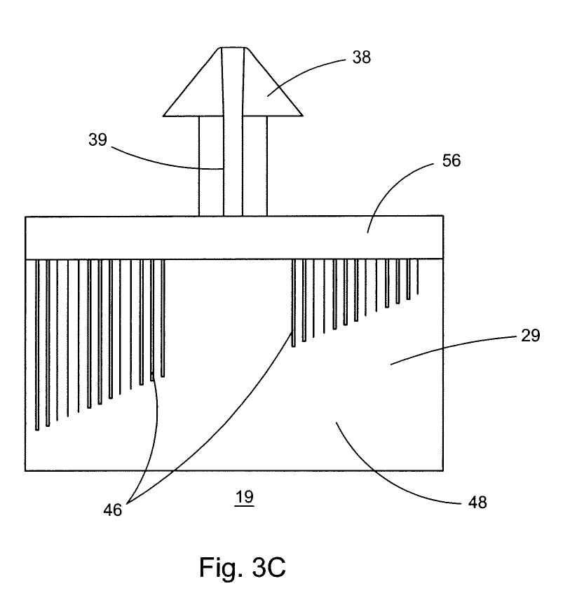

To generally describe features of the invention, a connector 19 for the HSA is illustrated in FIGS. 2A-2B and 3A-3C. The connector 19 may include a connector body 29, two retention fasteners 30 extending from a surface 20 of the connector body 29, and a mating interface 34. The connector body 29, the retention fasteners 30 and the mating interface 34 may be molded together into a single unit. By molding the connector body 29, the mating interface 34 and the retention fasteners 30 into a single unit, the HSA may not require the use of metal screws. Accordingly, the invention may reduce the loading forces, thereby reducing the warp in the PCB.

The connector 19 may be manufactured using injection molding methods well known in the art. The connector 19 does not have to be manufactured using molding techniques, however, and may be manufactured using other methods capable of forming the connector body 29, the retention fasteners 30, and the mating interface 34 into a single unit. Preferably, the connector 19 is manufactured from plastic, however is not limited to such a material.

The retention fasteners 30 may be self-locking pegs extending from the surface 20 of the connector body 29. In the embodiment depicted, the fasteners 30 may extend from the surface 20 at opposite ends of the connector body 29. A fastener 30 may contain a head 38 that may be cone shaped and compliant. The head 38 may extend from the end of a cylinder that extends from the surface 20 of the connector body 29. The base of the head 38 may have a larger diameter than the diameter of the cylinder so that the fastener is capable of locking the connector 19 to the disc drive housing.

The retention fasteners 30 may be capable of locking the connector 19 to the disc drive housing by inserting each retention fastener into a corresponding opening of the disc drive housing. Accordingly, the disc drive housing may have an opening for each fastener 30. Each opening, may be capable of receiving each fastener 30, thereby holding the connector securely to the disc drive housing. As the fasteners 30 are loaded into the openings of the disc drive housing, the heads 38 may compress allowing them to be received by the openings. Once fasteners 30 are through the openings, the heads 38 may decompress locking the connector 19 in place. The connector 19 may be locked into place because the base of the decompressed head 38 may be larger than the opening of the disc drive housing. Accordingly, if the connector 19 were to be pulled, at least a portion of the base of the head 38 would contact the disc drive housing, thereby preventing the connector 19 from being removed. The fasteners 30 are not limited to such a design, and may include other fastener designs that are capable of securely holding the connector 19 to the disc drive housing. The disc drive housing may be of any design capable of receiving the HSA.

The mating interface 34 may be any standard style two piece interface that does not translate loads to the stack assembly. For example the mating interface 34 may be a two piece blade on beam connector. The mating interface 34 may be capable of mating with a PCB mount connector. The mating interface 34 may have a plurality of contact pads 42 to provide a conductive path through a plurality of traces 46 to the flex circuit 12. The contact pads 42 may be made of a conductive material, such as metal. The mating interface 34 may be of any given pitch. For example the pitch may be 1 mm, 0.8 mm, 0.6 mm, or 0.5 mm, however, the mating interface 34 is not limited to such pitches.

The traces 46 may be disposed onto the connector 19 using standard methods known in the art. For example, the traces 46 may be etched onto the connector 19. The traces 46 may be coupled to the contact pads 42, thereby creating a conductive path from the contact pads 42 to the flex circuit 12. Preferably, the traces 46 may run along the surface 20 onto a second surface 48. By having the traces 46 run onto the second surface 48, the flex circuit 12 may be easily attached without interference from other components of the HSA. The second surface 48 may be any surface on the connector 19. The traces 46, however, are not limited to such an orientation. For example, the traces 46 may run onto several surfaces of the connector 19, or even be restricted to the surface 20. Further, the traces 46 do not have to be on a surface and may be embedded within the connector 19. Generally, the traces 46 may have any orientation on the connector 19 that allows for the flex circuit 12 to come in contact with the traces 46.

Flex circuit 12 may be any standard flex circuit and may be attached to the connector 19 using a clip 50 as shown in FIG. 1B. The clip 50 is not required, and the flex circuit 12 may be attached to the connector 19 using any method ensuring that the flex circuit 12 remains in contact with the traces 46. For example, the flex circuit 12 may be soldered to the traces 46 of the connector 19.

As shown in FIGS. 3A-3C, a gasket 56 may be disposed on the connector 19. The gasket 56 may be any material suitable to seal the connector 19 against the drive housing. For example the gasket 56 may be a material that has the correct compliance to seal the opening. The gasket 56 may also be made of a material that does not outgas, and meets the specifications of the drive HDA. Furthermore, the gasket 56 may be made of a material that meets environmental requirements of the drive interface and retain its form over time. The gasket 56 may be placed on the surface 20 of the connector body 29, so that retention fasteners 30 and mating interface 34 will be sealed within the gasket 56 when the connector 19 is connected to the disk drive housing.

What is claimed:

1. A connector for a head stack assembly, the connector comprising:
a connector body;
a mating interface extending from a surface of the connector body; and
a retention fastener extending from the surface of the connector body;
wherein the connector body, the mating interface, and the retention fastener are molded together into a single piece connector.

2. The connector of claim 1, further comprising a gasket disposed on the surface of the connector body.

3. The connector of claim 1, wherein the retention fastener is a peg.

4. The connector of claim 3, wherein the peg is self locking.

5. The connector of claim 1, wherein the connector body is plastic.

6. The connector of claim 1, wherein the retention fastener is a snap.

7. The connector of claim 1, wherein the mating interface communicates with a printed circuit board mount connector.

8. The connector of claim 1, further comprising a flex circuit.

9. The connector claim 8, wherein the connector body includes a clip to couple the flex circuit to the connector body.

10. A head stack assembly comprising:
a connector having a connector body, a mating interface and a retention fastener all molded together into a single piece connector;
a flex circuit coupled to the connector; and
a gasket seal disposed on a surface of the connector.

11. The head stack assembly of claim 10, wherein the retention fastener holds the gasket and connector to a drive housing.

12. The head stack assembly of claim 10, wherein the retention fastener is a peg.

13. The head stack assembly of claim 10, wherein the flex circuit is soldered to the connector body.

14. The head stack assembly of claim 10, wherein the connector body further includes a clip to couple the flex circuit to the connector body.

15. The head stack assembly of claim 12, wherein the peg is compliant.

16. The head stack assembly of claim 12, wherein the peg is self locking.

17. The head stack assembly of claim 10, wherein the connector is plastic.

18. The head stack assembly of claim 10, wherein the mating interface communicates with a printed circuit board mount connector.

19. The head stack assembly of claim 10, wherein the retention fastener is a snap.

20. A disc drive, comprising:
a head stack assembly comprising;
a connector having a connector body, a fastener extending from a surface of the connector body, and a mating interface extending from the surface of the connector body, wherein the connector body, the fastener and the mating interface are molded into a single piece connector;
a flex circuit coupled to the connector body; and
a gasket disposed on the surface of the connector body;
a disc drive housing capable of receiving the fastener; and
a printed circuit board mount connector capable of communicating with the mating interface.
